(19) United States
(12) Patent Application Publication
(10) Pub. No.: US 2025/0030678 A1
(43) Pub. Date: Jan. 23, 2025

(54) SYSTEMS AND METHODS FOR FACILITATING PASSKEY LOGIN TO A WEB DOMAIN

(71) Applicant: Shopify Inc., Ottawa (CA)

(72) Inventors: Jorge Quan Chau, Waterloo (CA); Mark Polivchuk, Calgary (CA); Cong Yue, Fairfax, VA (US); Gioele Salvatore Antoci, Chambly (CA); Mathieu Perreault, Mont Royal (CA)

(21) Appl. No.: 18/354,965

(22) Filed: Jul. 19, 2023

(51) Int. Cl. H04L 9/40; H04L 67/146

(52) U.S. Cl. CPC H04L 63/083; H04L 67/146

(57) ABSTRACT

A server for a web domain enables users to log in to user accounts at the web domain using passkeys, or cryptographic keys defined by a standard such as the Web Authentication (WebAuthn) standard. Before a user has logged in to an account, the server receives an identifier associated with a browser application, which is executing on a client device and which is used to access a webpage of the web domain. Based on the identifier, the server determines that a passkey for the web domain is likely to be accessible by the browser application at the client device. Responsive to determining that the passkey is likely to be accessible, the server causes the browser application to display a control to log in to an account at the web domain using the passkey.

### TECHNICAL FIELD

The present disclosure relates to facilitating login to web services.

### BACKGROUND

Passkeys are cryptographic keys stored on a user device to facilitate login to an online service from the user device. Passkeys can improve login to an online service because they are more secure than a password and are faster to use than a traditional two-factor authentication.

### BRIEF DESCRIPTION OF THE DRAWINGS

Detailed descriptions of implementations of the present invention will be described and explained through the use of the accompanying drawings.

FIG. 1 is a block diagram illustrating passkey-based login to an online service, according to some implementations.

FIG. 2 is a block diagram illustrating an environment in which a web service operates, according to some implementations.

FIG. 3 is a flowchart illustrating a process for managing login to a web service, according to some implementations.

FIGS. 4A-4E illustrate example user interfaces displayed during a login flow.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Web Authentication (WebAuthn) is a standard that has been developed to use cryptographic keys, referred to as “passkeys,” to facilitate passwordless authentication over the Internet. A web service can use the WebAuthn standard to offer passkey-based login to users of the web service.

According to implementations herein, a server for a web domain receives an identifier associated with a browser application, which is executing on a client device and which is used to access a webpage of the web domain. Based on the identifier, the server determines that a passkey for the web domain is likely to be accessible by the browser application at the client device. When the server determines that the passkey is likely to be accessible, the server causes the browser application to display a control to log in to an account at the web domain using the passkey.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Passkey Login

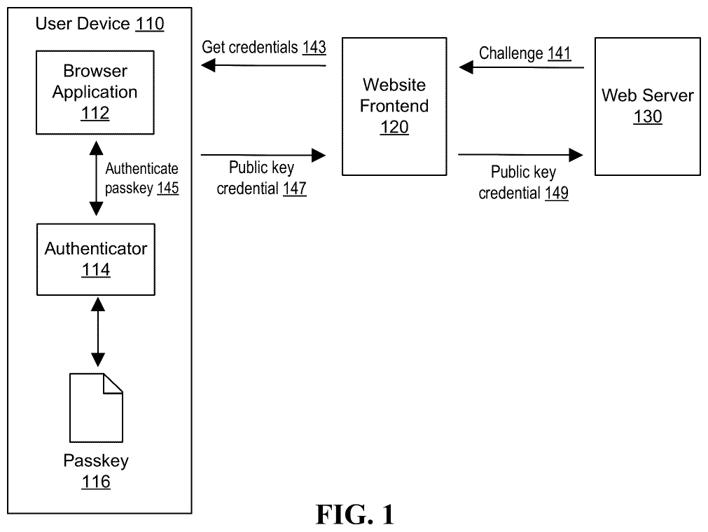

FIG. 1 is a block diagram illustrating passkey-based login to an online service, according to some implementations. As shown in FIG. 1, a process for logging in to an online service can include interactions between a user device 110, a website frontend 120, and a web server 130.

The web server 130 maintains an account database that includes public keys and other metadata associated with passkeys. When a passkey is created on a user device, the user device sends the web server 130 a public key associated with the newly generated passkey. The web server 130 stores the public key in the account database, in association with information about a user account of a user, for subsequent login to the user account.

The website frontend 120 communicates with a browser application 112 on the user device 110 to serve content from the web server 130 to the browser 112. The website frontend 120 sends fetch requests to the web server 130, for example to request content from the web server 130 and as the browser application 112 interacts with the requested content.

The user device 110 includes the browser application 112 and an authenticator 114. The authenticator 114 creates and stores passkeys on the user device 110. For example, to illustrate passkey-based login, FIG. 1 shows that the authenticator 114 has previously stored a passkey 116 on the user device that is configured for log in to the web server 130.

When the browser application 112 accesses the website frontend 120, the frontend requests a challenge from the web server 130. The web server 130 responds with the public key challenge at operation 141 shown in FIG. 1. The website frontend 120 then makes a call to the browser application, at operation 143, to get credentials associated with the public key challenge.

If the user of the browser application 112 initiates login to the web server 130 (e.g., by selecting a “login” control displayed on a webpage, placing a cursor in a sign-in field such as a username or password entry field, or the like), the browser application 112 presents the credentials associated with the public key challenge to the user. Once the user selects a credential, the browser application 112 calls the authenticator 114 to authenticate the passkey 116, at operation 145, based on the selected credential. The authentication of the passkey 116 can include authentication of a user of the user device 110, in some implementations. For example, the authenticator 114 may request a device password or screen lock passcode from the user or a fingerprint scan, a face scan, or a voice fingerprint of the user.

The authenticator 114 can be specific to the browser application 112. If the user device 110 is executing multiple different browser applications, each of these applications may use its own authenticator 114 to create and access passkeys. The authenticator 114 associated with one browser application may not be able to access or read a passkey generated for another browser application.

In some cases, the authenticator 114 may be able to access a passkey that is not stored on the user device 110. For example, some browser applications 112 may be configured to display a quick response (QR) code that, when scanned by another user device storing the passkey, causes an authenticator on the other user device to generate the signature based on the passkey and return the signature to the browser application 112. Some user devices can also be configured to share passkeys or passkey-generated signatures, for example by storing passkeys on a cloud-enabled account or by transmitting signatures via peer-to-peer communications channels.

Once the authenticator 114 has completed its authentication of the passkey 116 and, if applicable, the user, the user device 110 returns a signature to the website frontend 120, at operation 147. The signature is generated based on the passkey. The frontend 120 sends the signature to the web server 130 at operation 149, enabling the web server 130 to verify the signature using a public key associated with the user account. If the signature received from the website frontend 120 is validated based on the public key in the account database maintained by the web server 130, the user is signed into the user account.

When a passkey is accessible to a browser application 112 and the process shown in FIG. 1 can be used to log in to a user account at a web service, passkeys provide a secure, easy-to-use login method. For example, security can be improved without requiring users to remember complex passwords or have access to a second device for two-factor authentication. However, before a browser application attempts to retrieve a passkey for a given web service, the browser application does not expose to the web service whether credentials exist for a passkey until a challenge is fetched and passed to the browser. Based on this limitation, the browser application and web service may improperly begin a process for passkey-based login when no passkey is available. While attempting to login, the browser application may navigate a user through several options to find a passkey on the device executing the browser application or on other devices, before the login ultimately fails when no passkey is found at these locations. If there is no passkey available to the browser application, these login steps can delay the user from logging into the service and thereby degrade user experience, possibly causing the user to leave the webpage.

### Facilitating Login to an Online Service

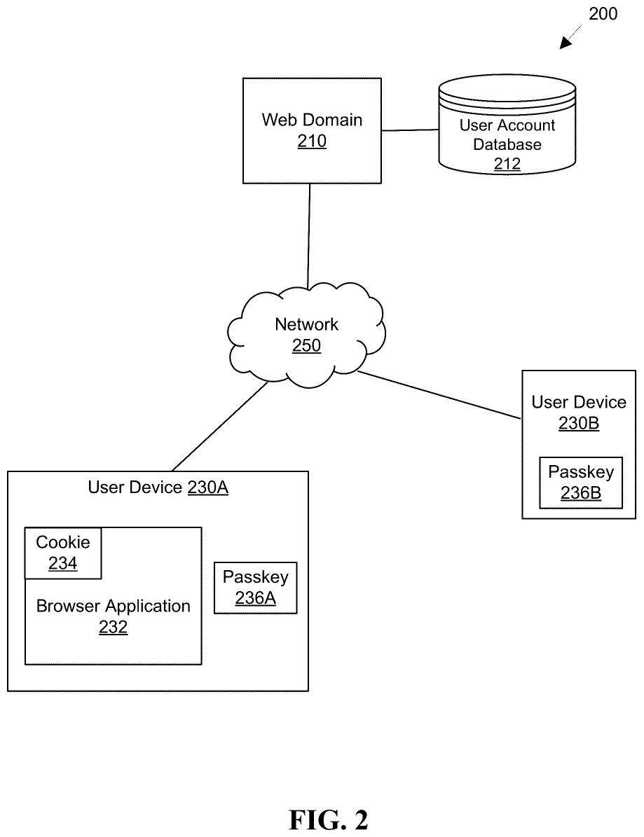

FIG. 2 is a block diagram illustrating an environment 200 in which a web service operates, according to some implementations. As shown in FIG. 2, the environment 200 includes a web domain 210 and one or more user devices 230, which communicate over a network 250 (such as the Internet). Other implementations of the environment 200 can include additional, fewer, or different entities.

The web domain 210 represents a set of services that are accessible by user devices or other network domains via the network 250. For example, the web domain 210 maintains a website that can be accessed by the user device 230. The web domain 210 can be operated by one or more servers.

The web domain 210 maintains a user account database 212 that stores data associated with user accounts registered at the web domain. The user account data can include one or more identifiers that are usable to identify a user's account at the web domain. For example, the identifiers can include a telephone number for a mobile or landline telephone accessible to a user or an email address for an email account used by the user. As a user accesses content from the web domain, a server associated with the web domain can also add to the database information about the devices or applications that have communicated with the web domain. For example, the database can store identifiers associated with a user device that has communicated with the web domain (such as an identifier of the type of operating system on the user device, a device fingerprint of the user device, or an IP address used by the user device). Similarly, the database can store identifiers associated with a browser application that has accessed content from the web domain (such as an identifier of a browser type of the browser or a user-client string of the browser). The user account data maintained in the user account database can further include data applicable to a service provided by the web domain 210. For example, a web domain 210 that provides payment processing services stores in the database information such as one or more payment methods linked to the account (e.g., credit or debit card numbers, bank account numbers, or credentials for a third-party payment processing service), a billing address for the linked payment method(s), and/or a shipping address where the associated user receives shipments of physical goods.

The web domain 210 can further cause the user account database 212 to store information about passkeys associated with user accounts. For example, the database 212 can store a record that indicates that a passkey has been created for a user account identified by a username, email address, or telephone number. The database 212 can further store information describing when and how passkeys were used, such as an identifier of any devices or browser applications that have communicated with the web domain when a passkey was used for a given user account, or a timestamp identifying when a passkey was last used for a given user account or on a given user device.

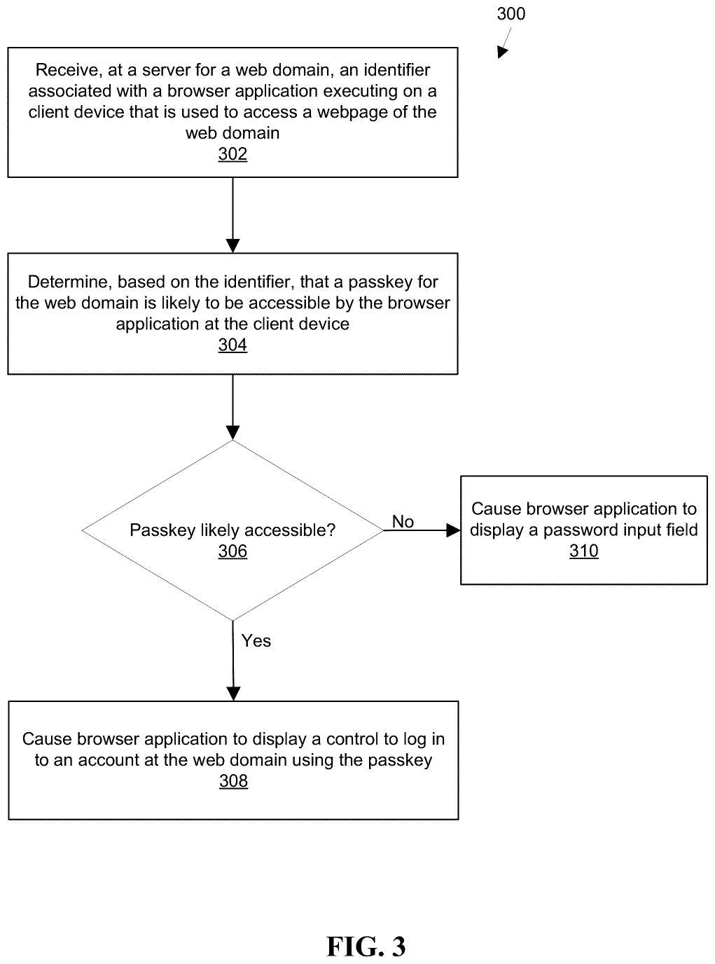

Users log in to their respective user accounts at the web domain 210 to access content or services of the web domain. The web domain 210 can support multiple methods for users to log in to their accounts. For example, users can create a username and password combination for their accounts or can provide an email account or phone number to which the web domain sends a one-time password whenever the users access their accounts. Password-based login can be supplemented by two-factor authentication. The web domain 210 can also support the use of passkeys to log in to user accounts. When a user accesses a web page of the web domain, prior to logging into a user account, the web domain 210 determines whether a passkey will likely be available to log the user into the user account. Because the web domain 210 cannot access local credentials stored on the user device executing the browser application, the web domain 210 evaluates the likelihood that a passkey is available based on one or more signals that correlate with a probability that a passkey is available. Depending on whether a passkey is determined to likely be available, the web domain 210 offers different login options to the user. A process by which the web domain manages login is described with respect to FIG. 3.

The user device 230 is a device used to access content from the web domain 210. The user device 230 can include, for example, a personal computer (PC), tablet computer, mobile telephone, game console, music player, wearable electronic device, network-connected (“smart”) device (e.g., a television or home assistant device), AR/VR systems (e.g., head-mounted display), or any other device capable of transmitting or receiving data over a network.

The user device 230 executes one or more browser applications 232, each of which is configured to access and display webpages from the web domain 210. As the browser application 232 accesses webpages from the web domain, the browser application can store one or more cookies 234 that are generated by the web domain as the browser application interacts with the web domain. The cookie 234 can maintain information such as login credentials for an account associated with the web domain, a unique identifier of a user of the browser application 232, or activity performed on the web domain. In some implementations, the web domain 210 stores a cookie with an indication (e.g., a flag) when a passkey is used to log in to the web domain 210 via the browser application 232.

The browser application 232 can be configured to support passkeys for logging into various web services. For example, the browser application includes code that enables it to create a passkey with the web domain 210, store passkeys locally on the user device 230, and use passkeys to log in to the web domain. When browser applications on different user devices (such as the user device 230A and user device 230B), or different browser applications on the same user device, are used to create passkeys, the passkeys may not be available to the browser application 232. For example, the browser application 232 on the user device 230A may not have access to the passkey 236B stored on the user device 230B. When a user is accessing the web domain 210 from the user device 230A, the user may not remember or may be mistaken about whether a passkey was created on the user device 230A or 230B. The user may also not remember which browser application was used to create the passkey.

FIG. 3 is a flowchart illustrating a process 300 for managing login to a web service, according to some implementations. The process 300 can be performed by a server associated with the web domain 210, which communicates with a browser application executing on a user device 230 that is used to access content from the web domain 210. Other implementations of the process 300 include additional, fewer, or different steps, or perform the steps in different orders.

At operation 302, the server of the web domain receives an identifier associated with a user that is accessing the web domain. User identifiers can include, for example, an email address, a phone number, a user-agent string, or an IP address. In some cases, the server accesses a cookie that was stored by the browser during a previous interaction between the browser and the web domain. The cookie can store data such as a user identifier (e.g., an email address) of a user who previously used the browser and logged into an account with the web domain. A cookie can additionally or alternatively store an indication that a passkey for the web domain has previously been used to login via the browser application. In other cases, the server receives a user-client string associated with the browser application or an IP address of the user device executing the browser application when the browser application accesses the webpage. The server can also provide an input field for the user to provide an identifier. For example, the server causes the browser application to display an entry field for an email address as a first login step. The user enters an email address to proceed to a next step of the login process.

At operation 304, the server determines, based on the identifier, that a passkey is likely to be accessible by the browser application at the user device. In some implementations, the server determines that a passkey is likely accessible to the browser application when the server identifies a match between the received identifier and an identifier in a user account database that is linked to an account with a passkey. In other implementations, the server determines a likelihood that the browser application has access to a passkey; if the likelihood is greater than a specified threshold, the server determines the browser application likely can use a passkey to log in to the web domain. This likelihood can be computed at least in part by the server generating a score that indicates a degree of match between multiple received identifiers and a set of identifiers associated with a user account. For example, a higher score is generated when both an email address and a browser identifier of the browser application match a user account that is known to have created a passkey for the web domain or is known to have used a passkey on the web domain. The likelihood determined by the server can also be based on an evaluation of an amount of time since a passkey associated with the retrieved identifier has been used to log in to the web domain. The server can also evaluate the likelihood that a passkey is stored (e.g., was generated) on another user device but is accessible to the browser application. For example, if the user is accessing the web domain from a first user device and the server determines that a passkey is likely stored on a second user device, the server determines a likelihood that the first user device can access the passkey from the second device (e.g., based on both devices using an operating system that is known to synchronize passkeys between the devices).

In some implementations, the server determines whether a passkey is likely accessible to the browser application by evaluating whether the browser application has a cookie indicating that a passkey has previously been used to log in to the web domain. Since the cookie storage and the passkey credential storage are managed by different processes on a user device, some implementations of the server use the cookie in combination with other signals, such as a degree of match between received identifiers and identifiers in a user account, an amount of time since the passkey was used, or whether the passkey is likely to be available via another device, to compute the likelihood score.

If a passkey is determined to be likely accessible (operation 306), the server causes the browser application to display (operation 308) a control to log in to an account at the web domain using the passkey. For example, the server causes the browser to invoke a conditional user interface with a selectable control to initiate passkey login. Alternatively, an icon is displayed within another user interface, where the icon is selectable to initiate passkey login.

If the determination at operation 306 results in a determination that the passkey is not likely accessible to the browser application at the user device, the server causes, at operation 310, the browser application to display an input field for another login method. For example, the browser application displays a password input field to receive a password for a user's account at the web domain.

By determining whether a passkey is likely to be available and modifying the displayed login options based on this determination, the server of the web domain facilitates seamless passkey-based login to the service while reducing the likelihood that a user will be confused or frustrated when a passkey is not available.

### Example Login Flows

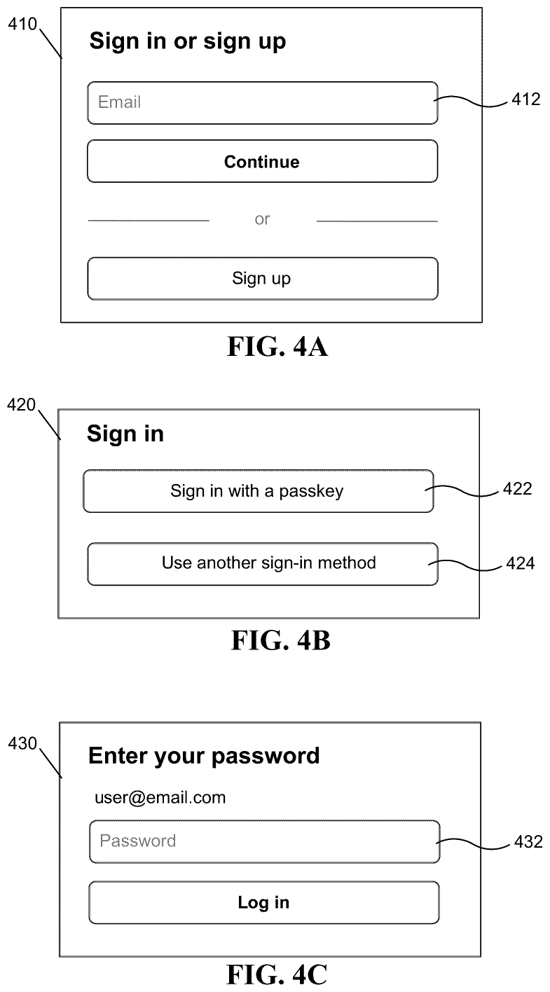

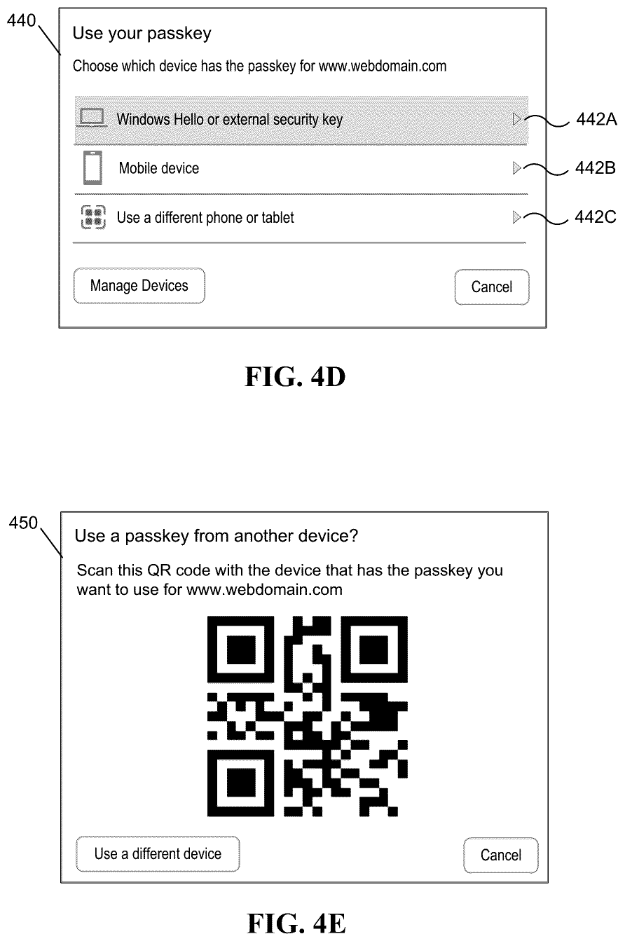

FIGS. 4A-4E are example user interfaces that the web domain 210 can cause the browser application 232 to display, which illustrate example login flows according to implementations herein.

FIG. 4A illustrates an example interface 410 that is displayed to initiate the login process. For example, the interface 410 is displayed as a login webpage that is retrieved when a user selects a “login” control from another webpage of the web domain, as a portion of another webpage of the web domain, or as a modal window that is displayed by the browser application 232. If the user has registered an account with the web domain, the user can enter an email address associated with the account in an entry box 412.

The web domain can use the email address entered by the user to look up the user account and determine whether the browser application 232 is likely to have access to a passkey for the web domain. If the web domain determines a passkey is likely available, the web domain can cause the browser application to display an example interface 420 illustrated in FIG. 4B. The interface 420 includes an option 422 to sign in with a passkey. In some implementations, the interface 420 can also include an option 424 to sign in with another method (e.g., password entry), in case the user knows that a passkey is not available or in case the user prefers a different method.

If the web domain determines a passkey is likely not accessible to the browser, the web domain can cause the browser application to display an example interface 430 illustrated in FIG. 4C. The interface 430 includes a password entry region 432, instead of a passkey option. The web domain can log in the user based on a password entered in the password entry region 432, without causing the browser application to display any passkey-related interfaces (such as the interfaces illustrated in FIGS. 4B, 4D, and 4E).

When the user selects the option in FIG. 4B to log in with a passkey, an interface 440 such as that illustrated in FIG. 4D can be displayed. The interface 440 includes options 442 to select the device where the passkey is stored. For example, the user selects option 442A if the passkey is stored on the device the user is currently using, option 442B if the passkey is stored on a mobile device that is at least partially synchronized with the device used by the user, or an option 442C if the passkey is stored on a different device. In some implementations, if the passkey is stored on the device the user is currently using, the browser application may automatically present the passkey and cause the interface 440 to be bypassed. If the user selects the option 442C to access a passkey on a different device, the web domain can cause the browser application to display an interface such as the interface 450 depicted in FIG. 4E. The interface 450 displays a QR code that can be scanned by the device that is storing the passkey. When the QR code is scanned by the other device, the other device is caused to generate a signature based on its stored passkey and to send the signature to the web domain to log the user into the web domain on the original device.

The user interfaces depicted in FIGS. 4A-4E illustrate one example login flow according to implementations herein. Other flows can be followed to conveniently log a user into the web domain while reducing the likelihood that the user will be misdirected to a passkey-based login when a passkey is unavailable. For example, if the web domain determines that a passkey is likely accessible to a browser application when the browser application accesses the web domain, the web domain can cause the browser to display the interface 420 (FIG. 4B) or the interface 440 (FIG. 4D) when a user selects a login control, bypassing the interface 410 (FIG. 4A). In another example, the web domain causes the browser application to display an interface with a password entry field (such as that illustrated in FIG. 4C), but if a passkey is determined to likely be available, this interface can include a control to instead log in with a passkey.

### Computer System

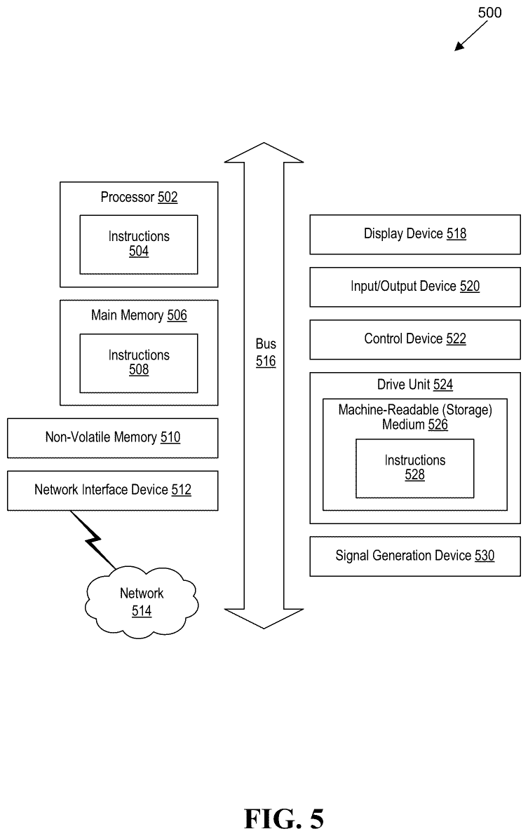

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A computer-implemented method comprising:
receiving, at a server for a web domain, an identifier associated with a browser application executing on a client device that is used to access a webpage of the web domain;
determining by the server, based on the identifier, that a passkey for the web domain is likely to be accessible by the browser application at the client device; and
responsive to determining that the passkey for the web domain is likely to be accessible by the browser application at the client device, causing the browser application to display a control to log in to an account at the web domain using the passkey.

2. The computer-implemented method of claim 1:
wherein receiving the identifier comprises receiving, at an input field displayed by the browser application, a user identifier.

3. The computer-implemented method of claim 2:
wherein determining that the passkey is likely to be accessible by the browser application comprises accessing a database that stores user identifiers and indications as to whether a given stored user identifier is linked to an account with a passkey.

4. The computer-implemented method of claim 1, wherein causing the browser application to display the control to log in to the account using the passkey comprises:
causing the browser application to invoke a conditional user interface with a selectable control to initiate passkey login.

5. The computer-implemented method of claim 1, wherein causing the browser application to display the control to log in to the account using the passkey comprises causing the browser application to display a selectable icon to initiate passkey login.

6. The computer-implemented method of claim 1, further comprising:
receiving, at the server, a second identifier associated with a second browser application that is used to access the webpage of the web domain;
determining by the server, based on the second identifier, that the passkey for the web domain is not likely to be accessible by the second browser application; and
responsive to determining that the passkey for the web domain is not likely to be accessible by the second browser application, causing the second browser application to display a password input field.

7. The computer-implemented method of claim 1, wherein receiving the identifier comprises retrieving the identifier from a cookie stored by the browser application.

8. The computer-implemented method of claim 7, wherein causing the browser application to display the control to log in to the account using the passkey comprises, in response to receiving a request to access a login webpage for the web domain, causing the browser application to display a login webpage with the control to log in to the account using the passkey.

9. The computer-implemented method of claim 8, further comprising:
receiving, at the server, a second identifier associated with a second browser application that is used to access the webpage of the web domain;
determining by the server, based on the second identifier, that the passkey for the web domain is not likely to be accessible by the second browser application;
and
responsive to determining that the passkey for the web domain is not likely to be accessible by the second browser application, causing the second browser application to display a login webpage without the control to log in to the account using the passkey.

10. The computer-implemented method of claim 1, wherein the client device is a first client device, and wherein determining that the passkey for the web domain is likely to be accessible by the browser application at the first client device comprises:
determining, based on the identifier, a likelihood that the passkey is stored on a second client device; and
determining a likelihood that the passkey is synchronized between the first client device and the second client device.

11. The computer-implemented method of claim 1, wherein the identifier comprises a plurality of identifiers associated with the browser application.

12. The computer-implemented method of claim 11, wherein determining that the passkey for the web domain is likely to be accessible by the browser application comprises:
accessing, by the server, a database storing identifiers received from data sessions in which the passkey was used to log in to the account; and
identifying a degree of match between the plurality of identifiers associated with the browser application and a subset of the identifiers stored in the database.

13. The computer-implemented method of claim 1, wherein the identifier comprises an identifier of the client device.

14. The computer-implemented method of claim 1, wherein receiving the identifier associated with the browser application comprises retrieving a cookie stored by the web domain on the client device.

15. The computer-implemented method of claim 1, wherein the passkey is a WebAuthn passkey.

16. The computer-implemented method of claim 1, wherein determining that the passkey is likely to be accessible by the browser application comprises:
determining, based on the identifier, a likelihood that the passkey is accessible by the browser application; and
responsive to the likelihood exceeding a threshold, determining the passkey is likely to be accessible by the browser application.

17. A system comprising:
at least one hardware processor; and
at least one non-transitory memory storing instructions, which, when executed by the at least one hardware processor, cause the system to:
receive an identifier associated with a browser application executing on a client device that is used to access a webpage of a web domain;
determine, based on the identifier, that a passkey for the web domain is likely to be accessible by the browser application at the client device; and
responsive to determining that the passkey for the web domain is likely to be accessible by the browser application at the client device, cause the browser application to display a control to log in to an account at the web domain using the passkey.

18. The system of claim 17, wherein the identifier comprises a plurality of identifiers associated with the browser application, and wherein determining that the passkey for the web domain is likely to be accessible by the browser application comprises:
accessing a database storing identifiers received from data sessions in which the passkey was used to log in to the account; and
identifying a degree of match between the plurality of identifiers associated with the browser application and a subset of the identifiers stored in the database.

19. The system of claim 17:
wherein receiving the identifier comprises receiving, at an input field displayed by the browser application, a user identifier.

20. The system of claim 17, wherein the identifier comprises an identifier of the client device.

21. The system of claim 17, wherein causing the browser application to display the control to log in to the account using the passkey comprises:
causing the browser application to invoke a conditional user interface with a selectable control to initiate passkey login.

22. The system of claim 17, wherein receiving the identifier associated with the browser application comprises retrieving a cookie stored by the web domain on the client device.

23. The system of claim 17, wherein determining that the passkey is likely to be accessible by the browser application comprises:
determining, based on the identifier, a likelihood that the passkey is accessible by the browser application; and
responsive to the likelihood exceeding a threshold, determining the passkey is likely to be accessible by the browser application.

24. A non-transitory computer readable storage medium storing executable instructions, execution of which by a processor causing the processor to:
receive, at a server for a web domain, an identifier associated with a browser application executing on a client device that is used to access a webpage of the web domain;
determine by the server, based on the identifier, that a passkey for the web domain is likely to be accessible by the browser application at the client device; and
responsive to determining that the passkey for the web domain is likely to be accessible by the browser application at the client device, cause the browser application to display a control to log in to an account at the web domain using the passkey.

25. The non-transitory computer readable storage medium of claim 24, wherein determining that the passkey is likely to be accessible by the browser application comprises:
determining, based on the identifier, a likelihood that the passkey is accessible by the browser application; and
responsive to the likelihood exceeding a threshold, determining the passkey is likely to be accessible by the browser application.
